(19) United States
(12) Patent Application Publication
(10) Pub. No.: US 2023/0173859 A1
(43) Pub. Date: Jun. 8, 2023

(54) COMBINED ROAD/RAIL WHEEL DEVICE FOR FOAD AND RAIL OPERATION

(71) Applicant: JOHANNES SCHERER, Munich (DE)

(72) Inventors: Johannes Scherer, Munich (DE); Jan NIEWOLIK, Augsburg (DE)

(21) Appl. No.: 18/097,216

(22) Filed: Jan. 14, 2023

Related U.S. Application Data
(63) Continuation of application No. PCT/DE21/00120, filed on Jul. 19, 2021.

(30) Foreign Application Priority Data
Aug. 24, 2020 (DE) D102020005156.1

(51) Int. Cl. B60F 1/02; B60B 19/02

(52) U.S. Cl. CPC B60F 1/02; B60B 19/02

(57) ABSTRACT

A combined road/rail wheel device that is adjustable by an adjusting device between road operation and rail operation, the combined road-/ rail wheel device comprising a wheel that is driven or not driven and configured to rotate about a wheel axis and includes a road tire with a tire running surface at an outer radial circumferential surface of the wheel and an axial inside and an axial outside oriented away from the axial inside; the adjusting device; a wheel flange arranged at the axial inside or the axial outside of the wheel, connected to co-rotate with the wheel and extendable by the adjusting device in its entirety or partially from a radially retracted position for road operation to a radially extended position for rail operation.

### RELATED APPLICATIONS

This application is a continuation of International application PCT/DE2021/000120 filed on Jul. 19, 2021 that claims priority from German patent application DE 10 2020 005 156.1 filed on Aug. 24, 2020, both of which are incorporated in their entirety by this reference.

### FIELD OF THE INVENTION

The invention relates to a combined road/rail wheel device that is adjustable by an adjustment device between road operation and rail operation according to the preamble of claim 1 and a road/rail chassis of a combined road/rail vehicle according to the preamble of claim 7 and a road/rail vehicle system according to the preamble of claim 9.

### BACKGROUND OF THE INVENTION

Road vehicles and rail vehicles have specific pros and cons. A road vehicle is individually controllable by a private operator with respect to a respective driving destination, however, it has a certain accident risk. Furthermore, the driving or travel time with a road vehicle depends on the capabilities of the driver. Last not least individual traffic with road vehicles also has certain environmental impacts. The disadvantages of the road vehicle can be at least partially overcome by a rail vehicle, however, rail vehicles are relatively inflexible due to the required rail network. In order to combine the advantages of rail vehicles and road vehicles combined road/rail wheel devices are known in the art.

A generic combined road/rail wheel device, a generic combined road/rail chassis and a generic combined road/rail vehicle are known from EP 1 862 334 A1. A rail car shunting device for shunting rail cars that are run on two parallel rails is disclosed. The rail car shunting device includes a chassis with four wheels with rubber tires supported thereon wherein each wheel is associated with a bolt that is movable by a adjusting device from a first retracted position for road operation where a bottom face of the bolt element is above a rolling plane of the wheel beyond the rolling plane towards a ground into a second extended position for rail operations where the bottom face of the bolt element is below the rolling plane so that the two outer circumferential surfaces of the bolt elements of two associated wheels extend along inner side flanks and/or outer side flanks of the rails in order to guide the wheels. Friction between the bolt and the lateral flank is a disadvantage since it causes undesirable wear.

### BRIEF SUMMARY OF THE INVENTION

Thus, it is an object of the invention to provide a combined road/rail wheel device, a combined road/rail chassis, a combined road/rail vehicle and a road/rail vehicle system that provides a high level of flexibility combined with little wear and low technical complexity.

The object is achieved by the features of the independent claims 1, 7 and 9. Advantageous embodiments are defined in the independent claims.

A first embodiment of the invention relates to a combined road-/rail wheel device that is adjustable by an adjusting device between road operation and rail operation, the combined road-/rail wheel device comprising:

a) a wheel that is driven or not driven to rotate about a wheel axle and includes a road tire with a tire running surface at an outer radial circumferential surface of the wheel and an inside and an outside oriented away from the inside;

b) the adjusting device.

According to the first embodiment of the invention, the combined road/rail vehicle device furthermore comprises:

c) a wheel flange arranged at an inside and/or an outside of the wheel, connected to co-rotate with the wheel and extendable by the adjusting device in its entirety or partially from a radially retracted position for road operation, to a radially extended position for rail operation,

d) wherein a radially outer wheel flange circumferential surface of the wheel flange extends radially at the most to the tire running surface in the radially retracted position and extends radially beyond the tire running surface in the radially extended position, and

e) wherein a wheel flange side surface of the wheel flange is oriented orthogonal to the wheel axle and configured to engage a side flank of a rail head of a rail of a rail track, and/or wherein the rail flange circumferential surface of the rail flange is configured to engage a track channel of a grooved rail of a rail track in the radially extended position of the wheel flange.

Typically trams and trolleys run on grooved rails, and suburban or long-haul trains run on rails with a rail head. The invention also relates to a monorail system, this means a rail track with only one rail instead of two rails. Thus, two wheel flanges can be provided per wheel, wherein one wheel flange engages a respective lateral flank of the rail head of the rail.

Since the wheel flange co-rotates with the wheel like in a wheel of a rail vehicle and consequently a circumferential portion of the wheel flange only temporarily engages a side flank of the rail head or engages the track channel of the groove rail and additionally rolls thereon, this causes much less wear than the prior art recited supra. Furthermore, a wheel with a co-rotating wheel flange is well proven in the field or rail vehicles and suitable for typical rail tracks. Furthermore, a wheel flange that is radially extendable and retractable by an adjustment device can be implemented in a simple manner, e.g. by wheel flange segments or wheel flange sectors that are distributed along a circumference of the wheel flange wherein the wheel flange segment or sectors are radially adjustable individually or in groups or all together between the radially retracted position and the radially extended position.

Therefore, the wheel flange can include plural radial guides, e.g. wheel flange sectors or wheel flange segments of a wheel flange base element that is connected with the wheel wherein the wheel flange segments are supported in radial guides and adjustable by the adjustment device with respect to their radial position between the radially retracted position and the radially extended position.

The adjustment device can include e.g. electrical, hydraulic and/or pneumatic actuators and spring elements through which the wheel flange sectors or wheel flange segments are preloaded either into the radially extended position or the radially retracted position. The adjustment device can also include an electronic control which controls the actuator or the actuators in a coordinated manner, in particular as a function of control signals of an input device which optionally predetermines a road operation or a rail operation of the combined road/rail wheel device. Advantageously the wheel flange sectors or wheel flange segments are distributed over an entire circumference of the wheel flange.

The wheel flange sectors or wheel flange segments can also form an essentially circular sector viewed in cross section.

Thus, the wheel flange sectors or the wheel flange segments can be supported in an extendable and retractable manner at a wheel flange base element of the wheel flange.

Furthermore, the adjustment device can be configured and controlled so that it performs the following adjustments when moving into the radially extended position of the wheel flange:

a) all wheel flange sectors or wheel flange segments are moved from the radially retracted position into the radially extended position or

b) only a wheel flange sector or wheel flange segment or wheel flange sectors or wheel flange segments are moved from the radially retracted position into the radially extended position which are in a circumferential portion of the wheel flange which is adjacent to the rail or groove rail when the wheel rotates and which moves the remaining wheel flange sectors or wheel flange segments into the radially retracted position or maintains them in the radially retracted position.

A second aspect of the invention relates to a combined road/rail chassis or a combined road/rail bogie of a combined road/rail vehicle, comprising at least one axle.

The invention then provides in a second embodiment that at least two combined road/rail wheel devices as described supra are included which are rotatably supported at the axle. For example, a trailer can include only one axle with two combined road/rail wheel devices. It is also conceivable that a vehicle with two or more axles includes only one axle with the combined road/rail vehicle devices according to the invention. Last not least all axles of a vehicle can be configured with the combined road/rail vehicle devices according to the invention. Thus, a respective combined road/rail vehicle device according to the invention is arranged at one end of an axle. The vehicle that is configured with at least one axle of the type recited supra then represents in particular a combined road/rail vehicle which is configured for road operation and for rail operation.

In the combined road/rail chassis the wheels of the two combined road/rail wheel devices advantageously have a track width at the axle which is adapted to a track width of the rail track. Then the wheels can roll on the rails with the running surfaces of the road tires while the wheel flange engages the lateral flank of the rail head of the rail or the track channel of a groove rail.

A vehicle configured with a combined road/rail chassis according to the invention cannot only be operated on a road under its own power, but also on a rail track.

A third embodiment of the invention relates to a road/rail vehicle system including a combined road/rail vehicle.

According to the second embodiment of the invention the combined road/rail vehicle then includes:

a) at least one combined road/rail vehicle chassis described supra; and

b) at least one super structure attached at the combined road/rail chassis and removeable therefrom without destruction, wherein the super structure includes a cab configured to transport persons and/or loads.

c) at least one drive device coupleable with the combined road/rail vehicle device and configured to drive at least one wheel of the combined road/rail vehicle device of the combined road/rail chassis.

The cab for transporting persons or loads broadly interpreted relates to a standard container for transporting goods or to a passenger cab configured to transport passengers and luggage.

The combined road/rail vehicle can be a vehicle that is exclusively controlled by the driver or a vehicle that is controlled or regulated assisted, partially automated, highly automated, fully automated or autonomously.

Advantageously the drive device of the combined road/rail vehicle can be integrated with the combined road/rail chassis to form a module. The drive device can be in particular an internal combustion engine or an electric motor. The drive device of the combined road/rail vehicle can also be integrated together with the cab or the super structure in a unit wherein drive coupling devices are provided which transfer the propulsion power from the cab or the super structure to the combined road/rail chassis or its driven wheels.

Furthermore, the combined road/rail vehicle system can include a group of differently configured super structures or cabs wherein coupling devices for the super structure and the cab and the combined road/rail chassis can be provided so that a super structure selected from the group can be coupled by the coupling devices with the combined road/rail vehicle chassis and decoupled again therefrom. This generates a modular road/rail vehicle system where various super structure modules or cab modules can be attached on a combined road/rail chassis configured as a standard module using the coupling devices and attached therefrom.

The road/rail vehicle system can include plural combined road/rail vehicles that are coupleable together by the coupling devices in rail operation and/or in road operation to form a vehicle interconnection.

In particular during road operations, a vehicle interconnection including plural combined road/rail vehicles coupled together can be pulled by a conventional locomotive or a conventional trolley which is e.g. only configured for rail operations. Self-propulsion of the combined road/rail vehicles can then be omitted, this means that the propulsion devices of the combined road/rail vehicles coupled together to form the vehicle interconnection are only operated until the rail track is entered and then deactivated during rail operations which is positive in an environmental aspect.

Thus, the coupling devices can include mechanical coupling devices and/or electronic coupling devices. The electronic coupling devices are used e.g. between members of a platoon, which is controlled by an overall operating strategy in particular of a lead vehicle of a platoon.

In the combined road/rail vehicle system the super structure or the cab can be transported by the combined road/rail chassis on a road or off road (road operation) or on a rail track (rail operation).

The combined road/rail vehicle system according to the invention enables a person to enter a cab coupled to a combined road/rail chassis at a starting point on a public road wherein the combined road/rail vehicle devices have been adjusted to road operation and to only leave the cab at a destination which is a train station. The combined road/rail chassis is switched to rail operation when the combined road/rail vehicle moves from the road onto the rail track.

The combined road/rail vehicle system according to the invention is particularly suited for transporting containers which are loaded e.g. onto a commercial vehicle or an interconnection of a towing vehicle or a trailer with a combined road/rail chassis and driven to a train station in road operation. At the train station the combined road/rail chassis is switched to a rail operation and the commercial vehicle or the composite of towing vehicle and trailer can drive to a destination train station under its own power together with the containers without having to unload the containers.

Overall, the invention saves time and increases comfort and safety. Rail operations become more attractive from an environmental point of view due to the ability of quickly adjusting from road operations to rail operations and vice versa.

In the embodiment of a combined flexible transportation system which includes the combined road/rail vehicle system according to the invention, the cab can also be configured to be transportable by an overhead rail system, a magnet rail system or a cable car system. Put differently the cab is disengaged from the combined road/rail chassis and then coupled by a coupling device with a movable transport element of the overhead rail system, the magnet rail system or the cable car system.

### BRIEF DESCRIPTION OF THE DRAWINGS

The invention is subsequently described based on advantageous embodiments with reference to drawing figures, wherein:

FIG. 1 illustrates a cross sectional view of a combined road/rail wheel device according to an advantageous embodiment of the invention including a wheel and a radially extendable and retractable wheel flange, fixed at the wheel so that it co-rotates with the wheel; and

FIG. 2 illustrates a perspective inside view of the combined road/rail wheel device according to FIG. 1 with a wheel flange sector of the wheel flange in the radially extended position.

### DETAILED DESCRIPTION OF THE INVENTION

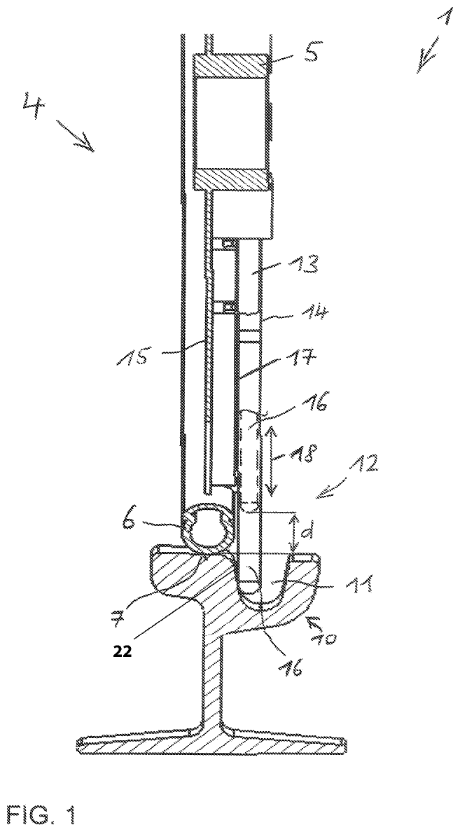

The advantageous embodiment of a combined road/rail wheel device illustrated in FIG. 1 is adjustable between road operations and rail operations by an adjustment device including at least one actuator 2. As evident from FIG. 1, a combined road/rail wheel device 1 is rotatably arranged at an end of an axle. The axle is part of a combined road/rail wheel device of a combined road/rail vehicle which is also switchable between road operation and rail operation due to plural combined road/rail vehicle devices in or at the combined road/rail chassis.

The combined road/rail wheel device 1 includes a wheel that is not driven in this embodiment and configured to rotate about the axle. The wheel 4 is rotatably supported at the axle by a wheel hub 5 and includes a rotor 6 with a tire running surface at its radially outer circumferential surface or rim shoulder. The road tire 6 which can also be configured for off road operations contacts a road surface in road operations with a tire running surface 7 or as illustrated contacts an upper running surface 8 of a rail head 9 of a groove rail 10 in rail operation wherein the groove rail is e.g. integrated in a road surface and typically configured to guide a trolley or tram. A track channel 11 of the groove rail 10 extends parallel to the running surface 8 in the same horizontal plane viewed in an operating position wherein the track channel is configured to guide a wheel flange 12 of the wheel 4.

A wheel disc 13 is arranged between the wheel hub 5 and the radially outer circumferential surface of the wheel 4 wherein the wheel disc includes an inside 14 and an outside 15 that is oriented away from the inside 14. The inside 14 and the outside 15 refer to a combined road/rail wheel device 1 rotateably arranged at an end of the axle wherein the insides 14 of the wheel disc 13 are oriented towards each other and the outsides 15 are oriented away from each other.

Thus, the wheel flange 12 is arranged e.g. at the inside 14 of the wheel disc 13 so that the wheel flange 12 co-rotates with the wheel 4. The wheel 4 can be in particular a conventional wheel of a road vehicle where the wheel flange 12 and the adjustment device 3 have been retrofitted.

The wheel flange 12 is adjustable in its entirety or partially by the adjustment device 3 between a radially retracted position for road operations and a radially extended position for rail operations.

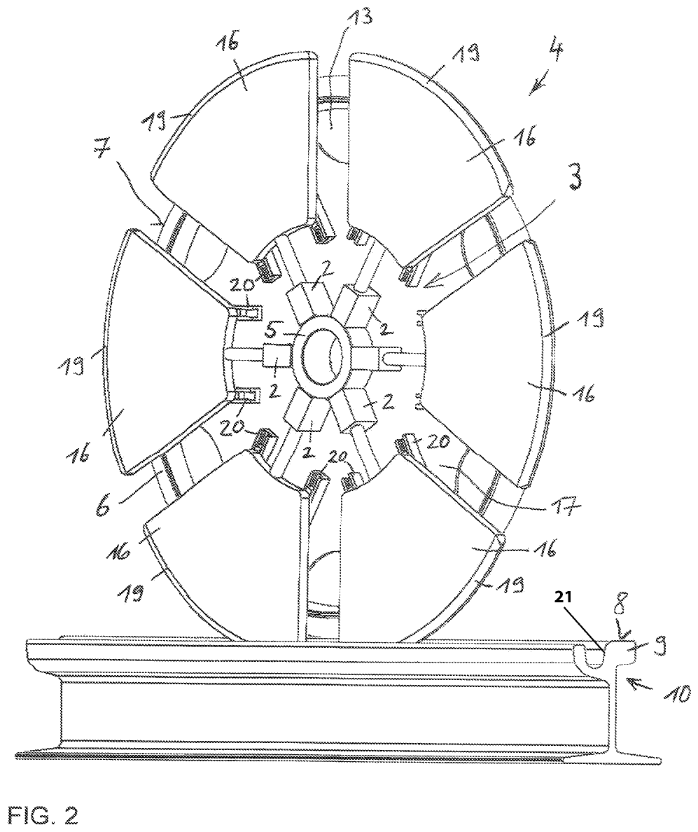

FIG. 1 shows the radially extended position of the wheel flange 12 in solid lines and the radially retracted position of the wheel flanged 12 in dashed lines. A radial movement direction of plural wheel sectors or wheel flange segment 16 which form the wheel flange 12, e.g. in combination with a disc shaped wheel flange base element 17 that is attached in particular at the inside 14 of the wheel disc 13 is designated in FIGS. 1 and 2 with arrows 18.

In the radially retracted position, a radially outer wheel flange circumferential surface 19 of the wheel flange does not extend viewed from a radial inside towards the tire running surface 7 of the road tire 6 but is offset from the tire running surface e.g. by a radial distance d, wherein the radially outer wheel flange circumferential surface 19 is represented herein by the radially outer wheel hub circumferential surfaces of the wheel flange sectors or wheel flange segments 16.

In the radially extended position of the wheel flange 12 the radially outer circumferential surface 19 of the wheel flange 12 extends by a certain distance radially beyond the tire running surface 7 so that the road tire contacts the running surface 8 of the rail head 9 and the radially outer circumferential surface 19 of the wheel flange 12 configured in this embodiment e.g. as a plate shaped body with rather small thickness, is configured to engage the track channel 11 of the groove rail 10 in order to guide the combined road/rail vehicle along the rail track. In order to facilitate this, the wheels 4 of the two combined road/rail wheel devices 1 have a track width at the axle which is adapted to a track width of the groove rails 10 of the rail track.

As evident from FIG. 2, and as stated supra, the wheel flange 12 can include plural plate shaped wheel flange sectors or wheel flange segments 16, supported in radial guides 20 of the wheel flange base element 17 connected with the wheel 4, wherein the wheel flange sectors or segments 16 are adjustable by the adjustment device 3 with respect to their radial position between the radially retracted position and the radially extended position. The wheel flange sectors or wheel flange segments 16 have e.g. a wedge-shaped contour as illustrated in FIG. 2 wherein the wedge edge forms the radially outer circumferential surface 19 of the wheel flange 12 and is configured to penetrate the track channel 11 of the groove rail 10.

Advantageously the wheel flange sectors or wheel flange segments 16 are distributed over an entire circumference of the wheel flange 12. The wheel flange sectors or the wheel flange segments 16 respectively form a circular sector or circular segment viewed in cross section, with a respective radially inner portion removed. Advantageously the wheel flange sectors or wheel flange segments 16 are distributed over the entire circumference of the wheel flange 12. Wheel flange segments 16 are supported at the wheel flange base element 17 by supports 20 in a retractable and extendable manner.

The adjustment device 3 can include e.g. electrical, hydraulic and/or pneumatic actuators 2, as well as e.g. spring elements that preload the wheel flange sectors or wheel flange segments 16 into the radially extended position or the radially retracted position. Thus, e.g. an individual actuator 2 can be provided for each wheel flange sector or wheel flange segment as illustrated in FIG. 1. Alternatively, an individual actuator 2 can be provided for all wheel flange sectors or wheel flange segments 16 or for a group of wheel flange sectors or wheel flange segments 16.

The adjustment device further includes an electronic control which controls the actuators 2 in a coordinated manner, in particular as a function of control signals of an input device which is configured to optionally determine road operation or rail operation of the combined road/rail devices 1.

The adjustment device 3 is furthermore advantageously configured and controlled by the electronic control so that it adjusts all wheel flange sectors or segments 16 from the radially retracted position into the radially extended position to establish the radially extended position of the wheel flange 12. Alternatively the adjustment device 3 can also be configured and controlled by the electronic control so that it only adjusts the wheel flange sector or segment 16 or the wheel flange sectors or wheel flange segments 16 from the radially retracted position into the radially extended position which are arranged in a circumferential portion of the wheel flange 12 which is opposite to the groove rail 10 when the wheel 4 rotates in order to establish the radially extended position of the wheel flange 12. Put differently only the wheel flange segments or wheel flange sectors 16 are adjusted from the radially retracted position into the radially extended position which are in contact with the groove rail 10 at a point in time, or which are about to come in contact with the groove rail 10. However, the remaining wheel Range sectors or segments 16 which are already out of contact with the groove rail 10 or not yet in contact with the groove rail 10 at a specific point in time are adjusted into the radially retracted position or maintained in the radially retracted position.

### REFERENCE NUMERALS AND DESIGNATIONS

1 combined road/rail wheel device
2 actuator
3 adjustment device
4 wheel
5 wheel hub
6 road tire
7 tire running surface
8 running surface
9 rail head
10 groove rail
11 track channel
12 wheel flange
13 wheel disc
14 inside
15 outside
16 wheel flange sector or wheel flange segment
17 wheel flange base element
18 arrow
19 radially outer circumferential surface
20 guide
21 side flank of rail head
22 wheel flange side surface
d distance

What is claimed is:

1. A combined road/rail wheel device that is adjustable by an adjusting device between road operation and rail operation, the combined road/rail wheel device comprising:
a wheel that is driven or not driven and configured to rotate about a wheel axis and includes a road tire with a tire running surface at an outer radial circumferential surface of the wheel and an axial inside and an axial outside oriented away from the axial inside;
the adjusting device;
a wheel flange arranged at the axial inside or the axial outside of the wheel, connected to co-rotate with the wheel and extendable by the adjusting device in its entirety or partially from a radially retracted position for road operation to a radially extended position for rail operation;
a radially outer wheel flange circumferential surface of the wheel flange that extends radially at the most to the tire running surface in the radially retracted position and extends radially beyond the tire running surface in the radially extended position,
wherein a wheel flange side surface of the wheel flange is oriented perpendicular to the wheel axis and configured to engage a side flank of a rail head of a rail of a track section in the radially extended position of the wheel flange, or
wherein the wheel flange circumferential surface of the wheel flange is configured to engage a track channel of a groove rail of a rail track in the radially extended position of the wheel flange.

2. The combined road/rail wheel device according to claim 1,
wherein the wheel flange includes plural wheel flange sectors or wheel flange segments that are guided along plural radial guides, and
wherein the wheel flange sectors or segments are adjustable with respect to their radial positions between the radially retracted position and the radially extended position by the adjustment device.

3. The combined road/rail wheel device according to claim 2, wherein the wheel flange sectors or wheel flange segments are distributed over an entire circumference of the wheel flange.

4. The combined road/rail wheel device according to claim 2, wherein the wheel flange sectors or wheel flange segments respectively form a circular sector or a circular segment in cross section.

5. The combined road/rail wheel device according to claim 2, wherein the wheel flange sectors or wheel flange segments are guided retractable and extendable at a wheel flange base element of the wheel flange.

6. The combined road/rail wheel device according to claim 2, wherein the adjustment device is configured and controlled so that it performs the following adjustments when establishing a radially extended position of the wheel flange:
all wheel flange sectors or wheel flange segments are moved from the radially retracted position into the radially extended position, or
only a wheel flange sector or wheel flange segment or wheel flange sectors or wheel flange segments are moved from the radially retracted position into the radially extended position which are in a circumferential portion of the wheel flange which is adjacent to the rail or groove rail when the wheel rotates and the remaining wheel flange sectors or wheel flange segments are moved into the radially retracted position or maintained in the radially retracted position.

7. A combined road/rail chassis of a combined road/rail vehicle, the combined road/rail chassis comprising:
at least one axle; and
at least two combined road/rail devices according to claim 1 rotatably arranged at the axle.

8. The combined road/rail wheel chassis according to claim 7, wherein wheels of the two combined road/rail wheel devices have a track width at the axle which is adapted to a track width of the rail track.

9. A road/rail vehicle system, comprising:
a combined road/rail vehicle including:
at least one combined road/rail vehicle chassis according to claim 7,
at least one super structure attached at the combined road/rail chassis and removeable therefrom without destruction, wherein the super structure includes a cab configured to transport persons or loads,
at least one drive device coupleable with the combined road/rail wheel device and configured to drive at least one wheel of the combined road/rail wheel device of the combined road/rail chassis.

10. The combined road/rail vehicle system according to claim 9, wherein the drive is integrated in a module together with the combined road/rail chassis.

11. The combined road/rail vehicle system according to claim 9,
wherein a group of different super structures is provided, and
wherein coupling devices are provided so that a super structure selected from the group is configured to be coupled by the coupling devices with the combined road/rail chassis or decoupled therefrom.

12. The combined road/rail vehicle system according to claim 8, comprising:
plural combined road/rail vehicles coupleable by coupling devices to form a vehicle interconnection in rail operation or in road operation.
